(19) United States
(12) Patent Application Publication
(10) Pub. No.: US 2008/0066992 A1
(43) Pub. Date: Mar. 20, 2008

(54) Power steering with an elastically mounted recirculating ball spindle gear

(76) Inventors: Helmut Bareis, Eschach (DE); Martin Budaker, Heubach (DE); Michael Jueschke, Spraitbach (DE); Roland Winter, Durlangen - Zimmerbach (DE); Oliver Hetzel, Waldstetten (DE); Michael Hauck, Schwaebisch Gmuend (DE)

Correspondence Address: JORDAN AND HAMBURG LLP, 122 EAST 42ND STREET, SUITE 4000, NEW YORK, NY, 10168, US

(21) Appl. No.: 11/903,824

(22) Filed: Sep. 24, 2007

Related U.S. Application Data
(63) Continuation of application No. PCT/EP2006/061166, filed on Mar. 30, 2006.

(30) Foreign Application Priority Data
Apr. 19, 2005 (DE) 10 2005 017 883.9

(51) Int. Cl. B62D 5/04

(52) U.S. Cl. 180/444

(57) ABSTRACT

A power steering system with a circulating ball spindle mechanism, an extending element of the circulating ball spindle mechanism being support rotatably over a bearing and the bearing of the element making possible a swiveling motion corresponding to the direction of action of interfering forces.

### BACKGROUND OF THE INVENTION

The invention relates to a power steering system with a circulating ball spindle mechanism.

A generic power steering system is known from the DE 103 10 492 A1.

The generic publication describes a steering mechanism, consisting of belts and pulleys. An output shaft of an electric motor and a push rod are each provided with a pulley and the pulleys are connected to one another with belts. Moreover, the push rod forms part of a ball and nut spindle mechanism unit, which furthermore comprises an eccentric ring, a ball nut or steering, a bearing and a pulley. Together with the ball nut, the push rod forms essentially a recirculating ball screw. The ball nut is mounted by means of the bearing in a steering housing.

The eccentric ring enables the axial distance between an output shaft of the electric motor and the push rod to be varied, so that, so that the belt and/or the pulleys can be installed without pre-tension.

In mounting the ball nut, it is essential that the mounting has a minimum clearance in the axial as well as in the radial direction. Moreover, the mounting should have certain swiveling properties. In this connection, grooved ball bearings as well as four-point ball bearings are known from the general prior art. Admittedly, the grooved ball bearings have good swiveling properties; however, they also have much axial clearance. Conventional four-point ball bearings admittedly have little axial clearance; however, they have only minimum swiveling properties. Soft-mounted four-point ball bearings (mounted, for example, over spring elements) of a more complicated structure and having further undesirable side effects, are also known.

Especially when the element to be mounted is a ball nut of a ball and nut spindle mechanism of a steering mechanism, which is suitable primarily for high axial forces, high steering tie rod forces arise while driving and can lead to an appreciable bending of the spindle. The transverse forces and the bending moments lead to an unequal distribution of loads in the mechanism unit and to additional loads on the individual components (ball nut, spindle, ball). The necessary service life is not achieved if these loads are impermissibly high.

Transverse forces and bending moments occur partly also as a consequence of tolerances, shape and positional deviations or adjusting processes already during the installation and result in strains and increases in friction up to jamming.

Reference is made to the DE 100 52 275 A1 and the EP 0 101 579 B1 and the EP 0 133 003 B1 in connection with the further prior art.

### SUMMARY OF THE INVENTION

It is therefore an object of the present invention to provide a power steering system with a circulating ball spindle mechanism, an extending element of the circulating ball spindle mechanism being mounted rotatably and the mounting having very little axial clearance and good swiveling properties for equalizing interfering forces.

The inventive power steering system enables an extending element to be mounted in a steering mechanism with very little axial clearance and good swiveling properties or slewing angles and swiveling moments, in order to equalize interfering forces.

The invention is particularly suitable for supporting a ball nut of a ball and nut spindle mechanism unit of a steering mechanism, which has a belt and pulleys. The inventor has recognized that the transverse force portion and the direction of action of the steering tie rod forces, which essentially cause the interfering forces, depends on the sweep and deflection of the steering tie rod or of the vehicle, the direction of action admittedly not being constant but fluctuating within a limited tolerance range for the relevant load cases.

Pursuant to the invention, the mounting makes possible a swiveling motion corresponding to the direction of action of the interfering forces. In a preferred embodiment, the mounting has a bearing, which can be swiveled about at least one swiveling axis of the bearing, a swiveling axis of the bearing corresponding at least approximately to a swiveling axis of the interfering forces, in order to force the interfering forces of the element into a swiveling motion. The mounted components, including the bearing, can therefore be swiveled about a swiveling axis, which corresponds approximately to the optimum swiveling axis of the steering system or the swiveling axis resulting from the interfering forces. By establishing a preferred swiveling axis of the bearing, the inventive device may have a construction, which is structurally simple and suitable for permanent use.

It is advantageous if the bearing is part of a swiveling device, in which it is integrated directly, or is disposed or fixed within a swiveling device.

Preferably, the bearing is a ball bearing with very little axial clearance, for example, a four-point bearing.

The inventive solution makes possible a mounting with very little if any clearance, the mounting having a large slew angle with a swiveling moment, which can be extended about a preferred axis (bearing swiveling axis), which preferably corresponds to the swiveling axis of the interfering forces. High axial and radial forces are permissible for the mounting. The installation can be made stress free, resulting in a minimum effect on the friction in the steering system (or in any other systems). The inventive device makes possible a uniform distribution of loads even in the case of transverse forces, sagging (spindle sagging) and angular deviation and accordingly is particularly suitable for ball and nut spindle mechanisms.

The inventive device results in a longer service life of the mechanism unit and of the system as a whole.

Advantageous further developments and developments of the invention arise out of the dependent claims. Examples of the invention are shown diagrammatically in the following by means of the drawings.

### BRIEF DESCRIPTION OF THE DRAWINGS

FIG. 1 shows a diagrammatic representation of a circulating ball spindle mechanism of a steering system with a belt drive,

FIG. 2 shows the inventive device in a sectional representation in accordance with a first embodiment, the swiveling device having an inner ring and an outer ring, which are connected to one another by connecting bridges,

FIG. 3 shows the inventive device in a sectional representation of a second embodiment, which differs from the first embodiment owing to the fact that the inner ring of the swiveling device is formed by an outer ring of the bearing,

FIG. 4 shows the inventive device in a sectional representation of a third embodiment, which differs from the second embodiment owing to the fact that the swiveling device has an eccentric construction,

FIG. 5 shows the inventive device in a sectional representation of a fourth embodiment, the outer ring of the swiveling device, in contrast to the aforementioned embodiments, being replaced by an adjusting device,

FIG. 6 shows the inventive device in a sectional representation of a fifth embodiment, the swiveling device having a swiveling ring with two pegs, which are mounted at the outside of the swiveling ring in bearing elements in the housing,

FIG. 7 shows the inventive device in a sectional representation of a sixth embodiment, which differs from the fifth embodiment in that the swiveling ring is formed by an outer ring of the bearing,

FIG. 8 shows the inventive device in a sectional representation of a seventh embodiment, which differs from the sixth embodiment in that elastic elements are disposed in the region of the bearing element,

FIG. 9 shows the inventive device in a sectional representation of an eighth embodiment, which differs from the seventh embodiment in that an elastic element can be adjusted by means of a screw element, and

FIG. 10 shows the inventive device in a sectional representation of a ninth embodiment, which differs from the fifth embodiment in that the bearing is displaceable in the housing.

### DESCRIPTION OF THE PREFERRED EMBODIMENTS

The drawings shows a device for rotatably mounting extending elements in a steering mechanism.

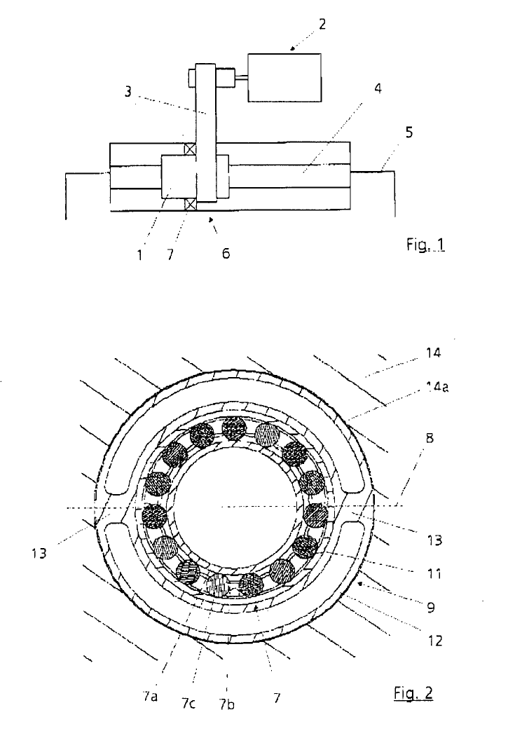

The inventive device is suitable in a preferred manner for the rotatable mounting of elements of a steering mechanism. FIG. 1 shows an example preferred for this purpose, the element being the ball nut 1 or steering nut 1 of a circulating ball spindle mechanism of a steering system. The mode of functioning of circulating ball spindle mechanisms is adequately known from the prior art. In this connection, reference is made, for example, to the DE 103 10 492 A1. FIG. 1 shows a driving unit 2, which derives the ball nut 1 over a belt 3. This leads to a linear or axial movement of a spindle 4, which deflects the wheels of a vehicle, the details of which are not shown, over steering tie rods 5. The ball nut 1 is mounted rotatably over a mounting 6, which makes a swiveling motion, which corresponds to the direction of action of the interfering forces (resulting essentially from the steering tie rod forces), possible.

FIG. 1 diagrammatically shows the arrangement of the mounting 6 of the ball nut 1. Different embodiments of the mounting 6 are shown in cross-section in FIGS. 2 to 10.

As is evident from FIGS. 2 to 10, the mounting 6 has a bearing 7 which can be swiveled about a swiveling axis 8 of the bearing. The swiveling axis 8 of the bearing corresponds approximately to a swiveling axis of the interfering forces, about which the interfering forces compel the ball nut 1 or the spindle 4 to carry out a swiveling motion. Since the direction of action of the interfering forces for the relevant load cases fluctuates in a limited tolerance region, the swiveling axis of the interfering forces can be calculated herefrom and the swiveling axis 8 of the bearing determined or aligned accordingly.

In the example, the bearing is a ball bearing 7 in the form of a 4-point bearing. In principle, other bearings are also suitable; preferably, they are bearings with very little axial clearance.

As shown in the following examples, the swiveling action is based on a deformation of a swiveling device 9 in itself and/or on a twisting in corresponding bearing elements 10.

FIG. 2 shows an arrangement of the ball bearing 7 in a swiveling device 9. The swiveling device is constructed as a swiveling ring 9, which has an inner ring 11 and an outer ring 12, which are connected with one another by connecting bridges 13. The ball bearing 7 is fixed in the swiveling ring 9. The ball bearing 7 has a conventional, known construction with an inner ring 7a and outer ring 7b, between which the balls 7c are disposed.

The inner ring 11 and the outer ring 12 of the swiveling ring 9 are connected with one another by two connecting bridges 13, which are disposed at least approximately aligned at opposite places of the swiveling ring 9. In this connection, the axis of the two connecting bridges 13 forms the swiveling axis 8 of the bearing.

For the sake of clarity, the ball nut 1 and the spindle 4 are not shown in FIG. 2 and the following Figures. The ball nut 1, the spindle 4 and the balls connecting the two elements are disposed in the usual manner and supported by the ball bearing 7.

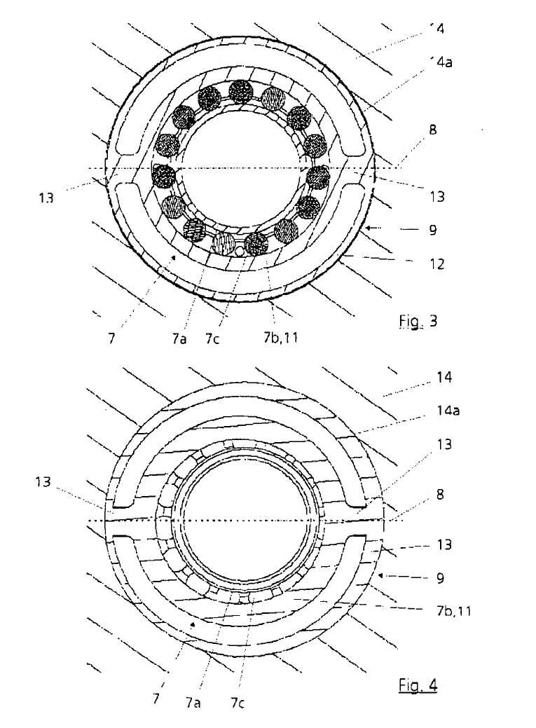

FIG. 3 shows a variation of the inventive device and differs from that of FIG. 2 in that the outer ring 7b of the ball bearing 7 forms the inner ring 11 of the swiveling ring 9. Analogously to FIG. 2, the latter is connected by two connecting bridges 13 with the outer ring 12. The axis of the two connecting bridges 13 once again represents the swiveling axis 8 of the bearing.

In order to equalize inclined positions, which arise already during the installation, the use of elastic elements is provided in an embodiment, which is not shown and is based on the embodiment shown in FIGS. 2 and 3. For this purpose, the swiveling ring 9 can be connected with a housing 14 by means of an elastic element, the elastic elements being disposed radially and/or axially at the swiveling ring 9.

FIG. 4 shows an embodiment of the inventive device, for which the swiveling ring 9 can be rotated in relation to a housing seat 14a. For this purpose, the swiveling ring 9 has an eccentric construction in such a manner, that the position of the ball nut 1 and, with that, also of the spindle 4 can be changed with respect to the housing 14.

The possibility of changing the position of the supported components relative to the housing 14 by means of an eccentric configuration of the swiveling ring 9 has proven to be particularly suitable especially when a belt drive is used, as is shown in FIG. 1, since adjustments, for example, to the belt tension, can thus be made easily.

The swiveling ring 9 of FIG. 4 is constructed similarly to the embodiment of FIG. 3, the outer ring 7b of the ball bearing 7 forming the inner ring 11 of the swiveling ring 9. The embodiment of FIG. 4 may, however, equally well have the construction of FIG. 2. In principle, the use of elastic elements (axially and/or radially) is possible with both variations, in order to be able to equalize inclined positions during the installation.

FIG. 5 shows an embodiment of the invention for which, as an alternative to twisting the swiveling ring 9 relative to a housing seat 14a, the swiveling ring 9 can be shifted in the housing 14. For this purpose, the swiveling ring 9 has an adjusting device 16, which enables it to change the position of the ball nut 1 and, with that, also that of the spindle 4 relative to the housing 14. Accordingly, analogously to FIG. 4, adjustments, such as the belt tension of a belt drive can be made easily. In principle, the swiveling ring 9 of FIG. 5 has a construction similar to that already described for the embodiment of FIG. 3, the outer ring 12 being replaced by the adjusting device 16. The adjusting device 16 has two fastening elements 16a, 16b which are disposed at the ends of the connecting bridges 13 averted from the inner ring 11. The fastening elements 16a, 16b maybe connected in any suitable manner with the housing 14, the displacement of the bearing in the housing 14 being based, for example, on the fact that the connecting bridges 13 can be shifted relative to the fastening elements 16a, 16b or that the attachment of the fastening elements 16a, 16b to the housing 14 can be shifted.

Analogously to the embodiment of FIG. 3, the outer ring 7b may also be formed in one piece with the inner ring 11 of the swiveling ring 9. In principle, the use of elastic elements, disposed axially and/or radially to the connection with the surrounding housing 14, is also possible for all embodiments of FIG. 5.

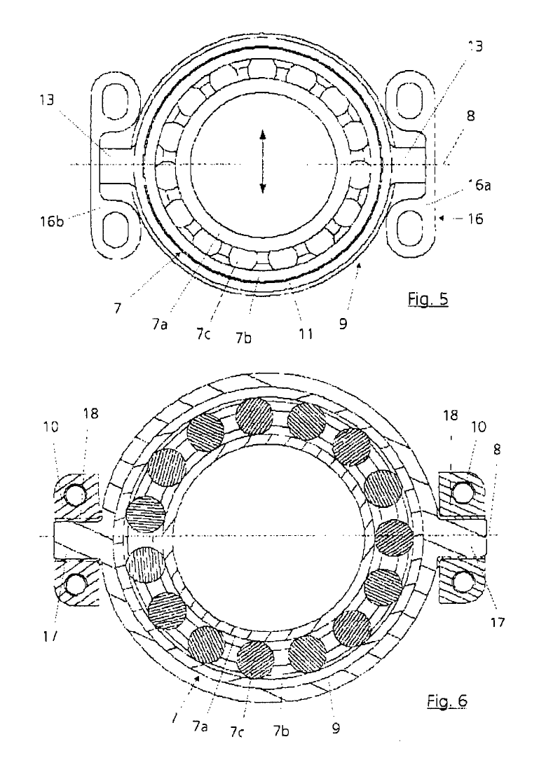

FIG. 6 shows an embodiment of the inventive device, for which the swiveling device is constructed as a swiveling ring 9, which has pegs 17, overhangs or the like, which can be mounted in bearing elements 10 in the housing at two opposite places of its outside. The pegs 17 may be disposed at the swiveling ring 9 or at the bearing elements 10, as preferred. Depending on the desired swiveling properties (swiveling moment, development of noise or the like), the pegs 17, as shown in FIG. 6, may be disposed by means of additional radial bearings 18 in the bearing elements 10. At the same time, the axes of the pegs 17 form the swiveling axis 8 of the bearing. The ball bearing 7 is fixed in the swiveling ring 9.

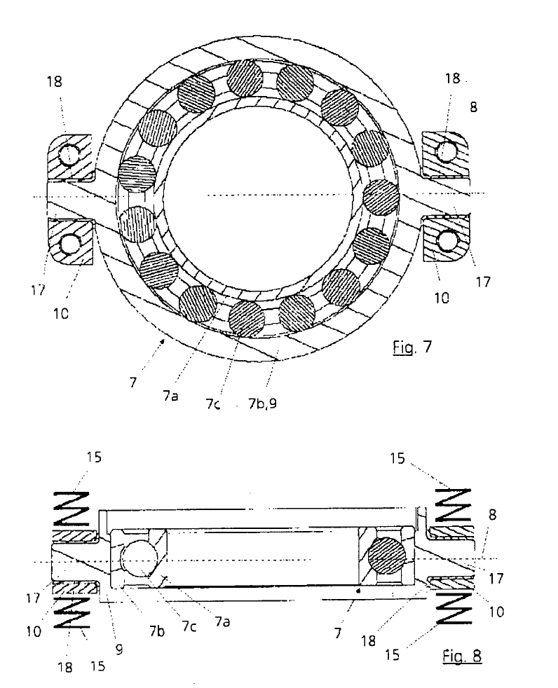

FIG. 7 shows an embodiment of the inventive device, for which, in deviation from the embodiment shown in FIG. 6, the swiveling ring 9 is formed by the outer ring 7b of the ball bearing 7. The further construction corresponds that of the embodiment of FIG. 6.

FIG. 8 shows a variation of the inventive device, which is suitable for the embodiment of FIG. 6 as well as for the embodiment of FIG. 7. Elastic elements 15 are provided in the region of the bearing elements 10 for equalizing installation stresses or inclinations, which arise during the installation. At the same time, the elastic elements 15 fulfill the same task as that of the already described elastic elements, which have, however, not been shown in the previous Figures. The elastic elements 15 enable the bearing elements 10 to be disposed movably with respect to the housing 14. In this connection, the bearing elements 10 may be connected with the housing 14 by means of axially and/or radially disposed elements 15.

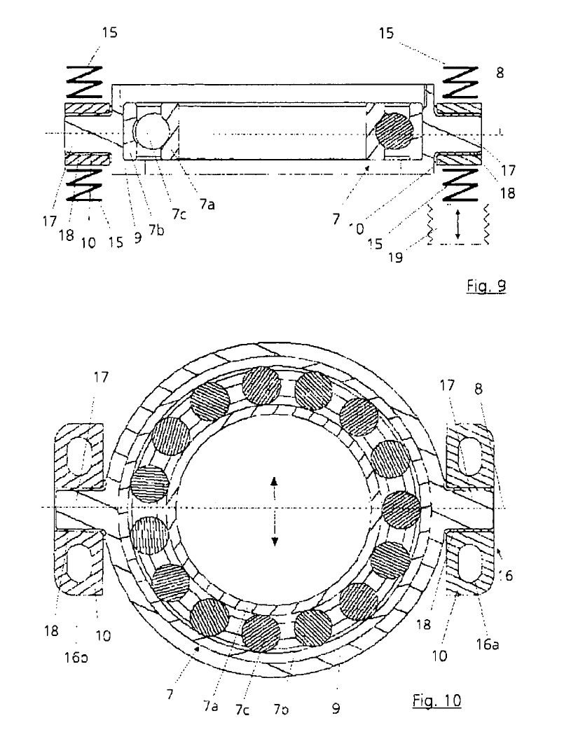

FIG. 9 shows a variation of the inventive device, for which, contrary to the embodiment of FIG. 8, the inclined position, which may arise during the installation, is acted upon. This is accomplished in that at least one elastic element 15 or the force of the latter acting on the bearing element 10 is adjustable. In accordance with the embodiment shown in FIG. 9, the adjustment is made with a screw element 19. However, a plurality of other possibilities also suggest themselves here from the general prior art.

FIG. 10 shows an embodiment of the inventive device, which differs from that of FIG. 6 owing to the fact that the bearing or the supporter elements (ball nut 1, spindle 4) can be displaced in the housing 14. The position of the supported components in the housing 14 is changed by shifting them and an adjustment, such as the tension of a belt drive, is made in this way. According to the embodiment shown in FIG. 10, the position of the bearing elements 10 can be changed with respect to the housing 14, as a result of which the position of the ball bearing 7 and of the supported components (ball nut 1, spindle 4) is also changed. For this purpose, the bearing elements 10 have elongated holes, which make it possible to change the position of the bearing elements 10 easily with respect to the housing 14.

The present, inventive device is suitable particularly for use with ball and nut spindle mechanism units, for which the ball nut is driven over a belt drive, for example, by an axially parallel driving mechanism, as shown diagrammatically in FIG. 1. However, the inventive device is not limited to this. Rather, the inventive device is also suitable for use with other devices, for which an element, which is affected by interfering forces (such as transverse forces, bending moments) is to be supported rotatably.

1.-24. (canceled)

25. A power steering system with a circulating ball spindle mechanism, an element of the circulating ball spindle mechanism extending axially along an axis of rotation and being mounted rotatably over a bearing, the mounting of the element making possible a swiveling motion corresponding to the direction of action of forces, wherein the bearing is part of a swiveling device, the swiveling device is constructed as a swiveling ring, the swiveling ring has two connecting bridges at opposite places, and the connecting bridges form a swiveling axis of the bearing.

26. The power steering system of claim 25, wherein the swiveling ring has an inner ring and an outer ring which are connected with one another by the connecting bridges.

27. The power steering system of claim 25, wherein the bearing can be swiveled about a swiveling axis of the bearing, the swiveling axis of the bearing corresponding at least approximately to a swiveling axis of the interfering forces, in order to force the interfering forces of the element to carry out a swiveling motion.

28. The power steering system of claim 25, wherein the bearing is disposed within a swiveling device.

29. The power steering system of claim 25, wherein the swiveling device is deformable.

30. The power steering system of claim 26, wherein the inner ring of the swiveling ring is formed by an outer ring of the bearing.

31. The power steering system of claim 25, wherein the swiveling ring is connected with a housing by means of elastic elements, the elastic elements being disposed radially and/or axially at the swiveling ring.

32. The power steering system of claim 25, wherein the swiveling device can be twisted with respect to a housing seat.

33. The power steering system of claim 32, wherein the swiveling device has such an eccentric construction, the position of the element, which is to be supported, can be changed with respect to the housing by twisting the swiveling device relative to the housing seat.

34. The power steering system of claim 25, wherein the bearing is displaceable with respect to a housing seat.

35. The power steering system of claim 34, wherein the swiveling device has an adjusting device, which makes it possible to change the position of the bearing and, with that, the position of the element, which is to be supported, with respect to the housing.

36. The power steering system of claim 26, wherein the outer ring of the swiveling ring is replaced by the adjusting device.

37. The power steering system of claim 25, wherein the swiveling device has a swiveling ring, which has pegs, which are aligned at least approximately at two opposite places of its outside and can be supported in bearing elements at the housing.

38. The power steering system of claim 37, wherein the pegs form the swiveling axis of the bearing.

39. The power steering system of claim 37, wherein the pegs are mounted in the bearing elements by means of radial bearings.

40. The power steering system of claim 37, wherein the swiveling ring is formed by an outer ring of the bearing.

41. The power steering system of claim 37, wherein the bearing elements are disposed movably with respect to a housing in order to equalize installation stresses.

42. A power steering system of claim 41, wherein the bearing elements are connected with the housing by means of elastic elements, which are disposed axially and/or radially at the bearing elements.

43. The power steering system of claim 42, wherein at least the force of an elastic element, acting on the bearing element, is adjustable.

44. The power steering system of claim 43, wherein the adjustment is accomplished by means of a screw element.

45. The power steering system of claim 25, wherein the bearing is a ball bearing with very little axial clearance.

46. The power steering system of claim 45, wherein the ball bearing is a four-point bearing.

47. The power steering system of claim 25, wherein the element is a ball-type linear drive of a circulating ball spindle mechanism of a steering system.
